(19) United States
(12) Patent Application Publication
(10) Pub. No.: US 2025/0077056 A1
(43) Pub. Date: Mar. 6, 2025

(54) ASYNCHRONOUS EMBEDDED USER INTERFACE AGENT

(71) Applicant: International Business Machines Corporation, Armonk, NY (US)

(72) Inventors: Zachary A. Silverstein, Georgetown, TX (US); Logan Bailey, Atlanta, GA (US); Fang LU, Billerica, MA (US); Tiberiu Sutony, Franklin, NY (US)

(73) Assignee: International Business Machines Corporation, Armonk, NY (US)

(21) Appl. No.: 18/240,109

(22) Filed: Aug. 30, 2023

(51) Int. Cl. G06F 3/04842; G06F 8/38; G06F 16/958

(52) U.S. Cl. CPC G06F 3/04842; G06F 8/38; G06F 16/986

(57) ABSTRACT

An embodiment establishes an interaction database based at least in part on interaction data received from a browser. The embodiment monitors the browser for one or more actions and stores the one or more actions detected as interaction data on the interaction database. The embodiment constructs an asynchronous user interface based at least in part on the interaction data stored on the interaction database, wherein the asynchronous user interface comprises a set of selection options. The embodiment receives, via the asynchronous user interface, a selection of a selection option of the set of selection options. The embodiment performs a responsive action upon having received the selection of the selection option of the set of selection options.

### BACKGROUND

The present invention relates generally to user interface technology. More particularly, the present invention relates to a method, system, and computer program for providing an asynchronous embedded user interface agent.

A user interface (“UI”) allows a person to interact with a digital system. Accordingly, a UI enables the effective operation and control of a machine from the human end. The goal of user interface design is to produce a UI that is easy to use and effective at enabling a user to complete a wide variety of tasks using a digital system. One of the greatest improvements to user interface design includes the development of the graphical user interface (“GUI”) which may include graphical elements that make it much easier for a user to interact with a digital device. GUIs are integrated into many electronic devices, including but not limited to, computers, smartphones, mobile devices, gaming devices, and various other household, office, and industrial devices.

The development of robotic process automation (“RPA”) has greatly increased user efficiency related to interacting with digital systems. RPA includes the development and utilization of software robots designed to automatously complete repetitive tasks. Accordingly, an RPA software robot (also referred to as an “RPA agent”) may emulate human interaction with a digital system, and may perform a wide array of actions, including, but not limited to, understanding what is displayed on a screen, navigating a system, performing a particular combination and/or sequence of keystrokes, identifying and extracting data, interacting with a user interface, and performing various other defined actions.

### SUMMARY

The illustrative embodiments provide for an asynchronous embedded user interface agent. An embodiment includes establishing an interaction database based at least in part on interaction data received from a browser. The embodiment also includes monitoring the browser for one or more actions and storing the one or more actions detected as interaction data on the interaction database. The embodiment also includes constructing an asynchronous user interface based at least in part on the interaction data stored on the interaction database, wherein the asynchronous user interface comprises a set of selection options. The also includes embodiment receiving, via the asynchronous user interface, a selection of a selection option of the set of selection options, and upon having received the selection, performing a responsive action via a software robot.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example process for software integration in accordance with an illustrative embodiment;

FIG. 3 depicts a block diagram of an example computing environment in accordance with an illustrative embodiment;

FIG. 4A depicts a block diagram of an example interface constructor module in accordance with an illustrative embodiment;

FIG. 4B depicts a block diagram of an example software architecture including an asynchronous user interface in accordance with an illustrative embodiment;

FIG. 5 depicts a block diagram of an example process for training an RPA agent in accordance with an illustrative embodiment;

FIG. 6 depicts a block diagram of an example user interface construction process in accordance with an illustrative embodiment;

FIG. 7 depicts a block diagram of multiple example state specific scenarios in accordance with an illustrative embodiment;

FIG. 8 depicts a block diagram of an multiple example user interfaces in accordance with an illustrative embodiment;

FIG. 9 depicts a block diagram of an example user interface in accordance with an illustrative embodiment;

FIG. 10 depicts a flowchart of an example process for providing a user interface in accordance with an illustrative embodiment; and

FIG. 11 depicts a flowchart of an example process of completing a task with an asynchronous user interface agent in accordance with an illustrative embodiment.

### DETAILED DESCRIPTION

People utilize digital technology most often by interacting with a user interface that in some way controls the functionality of the digital technology. A user interface typically includes components such as a list or an array of buttons that enable particular functions. Oftentimes, situations exist where these interface components might not always be available. For example, software may take time to propagate an enterprise update of a file's status, which makes it difficult or functionally impossible to make changes or click on an expected button. The button may be greyed out or not listed, even though the button may become available once again once the status or state resolves.

In consideration of the above depicted example scenario, a problem that currently exists related to user interface design includes the limited availability of functional components that may exist when a software is experiencing a non-fully functional state. Currently there is no way to provide the functionality of a user interface irrespective of a particular software state. The present disclosure addresses the deficiencies described above by providing a process (as well as a system, method, machine-readable medium, etc.) that develops an asynchronous user interface combined with a software robot to facilitate temporarily unavailable functionality of a user interface due to software state.

It is contemplated herein that the present disclosure includes a technological solution that addresses a problem specifically rooted in computer technology, specifically user interface technology. Further, it is contemplated herein that the present disclosure may not be performed in the human mind alone, as the human mind alone is not capable of providing a user interface to interact with a digital technology. Further, it is contemplated herein that embodiments of the present disclosure improve the underlying digital technology discussed, at least by providing increased functionality to a user interface given a non-fully functional software state.

As used throughout the present disclosure, the term “user interface” (or simply “UI”) refers to the point of human-computer interaction and communication in a device. More specifically, a UI as described in the present disclosure refers to a computer user interface. UI enables a user to interact with a digital system, software application, website, etc. Examples of UI components may include, but are not limited to, buttons, menus, lists, graphical elements, etc.

As used throughout the present disclosure, the term “robotic process automation” (or simply “RPA”) refers to software technology related to building, deploying, and/or managing software robots that emulate human actions performed while interacting with a digital system and/or software. RPA is often referred to as software robotics, and may include the utilization of a software robot, also referred to herein as an “RPA agent”. The robot (i.e., RPA agent) in robotic process automation may run on a physical and/or virtual machine. RPA tools may possess a number of technical similarities to user interface testing tools. Accordingly, RPA tools are used to automate interactions with a UI, and may be designed to do so by repeating a set of demonstration actions performed by a user. It is contemplated that RPA tools may enable data to be handled in and between multiple software applications. For example, an RPA agent may be configured to receive an email containing an invoice, extract data from the invoice, and insert that data into a spreadsheet based bookkeeping system.

An RPA agent may utilize input controls, e.g., keyboard and mouse controls, to take actions and execute automations. The actions taken by the RPA agent may be performed in a virtual environment without the use of a screen, whereby the RPA agent may not need a physical screen to operate, but instead may interpret a screen display electronically. In traditional workflow automation develop, a developer may produce a list of actions to automate a task and interface to the backend of the computer system using one or more application programming interfaces (“APIs”) and/or a dedicated scripting language. On the other hand, an RPA system may develop an action list by observing a user perform a task in an application's UI, and then perform the task autonomously by repeating the observed task in the UI. It is contemplated that RPA may enable automation in software products even when such software products do not include APIs configurable for automation development purposes.

As used throughout the present disclosure, the term “Document Object Model” (or simply “DOM”) refers to programming interface for HTML and XML documents that represents a page in tree structure so that programs can read, access, update, and/or change document structure, style, and content. A DOM is an object-oriented representation of a web page, which can be modified by a scripting language, e.g., JavaScript. Further, it is contemplated herein that every web browser may use some DOM to make web pages accessible to other applications. The DOM may comprise of a plurality of DOM elements organized in a tree structure.

As used throughout the present disclosure, the term “happy path” refers to a most direct path a user can take within a product to achieve a desired result. In the context of software or information modeling, a happy path is a default scenario featuring no exceptional or error conditions. Accordingly, a happy path test is a well-defined test case using known input, which executes without exception and produces an expected output. The happy path is meant to describe the ideal process, without any exceptions or alternate paths. For example, a happy path for logging into a system may include the steps of a user correctly entering the user's credentials to a login page of a system, the system authenticates the user, and the system grants the user access to the system. As used throughout the present disclosure, the term “user interaction session” refers to a period of engagement between a user and a software application. A user interaction session may include a number of actions taken by a user during the interaction session. Examples of types of actions that may be taken by a user during an interaction session may include, but are not limited to, selecting/clicking a UI element, entering text into a search bar, pressing a sequence and/or combination of keys, etc.

The illustrative embodiments provide for an asynchronous embedded user interface agent. Illustrative embodiments include constructing an asynchronous user interface based at least in part on interaction data, the interaction data including one or actions taken by a user during a user interaction session during which a user interacts with a user interface. Illustrative embodiments further include receiving one or more commands via the asynchronous user interface, and executing one or more actions via an RPA agent in response to having received the one or more commands.

Illustrative embodiments further include monitoring and analyzing user interactions to provide an asynchronous user interface that enables a user to accomplish one or more tasks via an RPA agent that is configured to autonomously complete the one or more tasks upon the availability of a suitable functional state that allows the performance of the one or more masks. Illustrative embodiments further include monitoring activity within a software application, including one or more interactions with a user interface within a software application browser for a period of time, and storing collected interaction session data on an interaction database.

In an embodiment, the asynchronous user interface receives a task completion command upon the user selecting/clicking one or more options of a set of selection option, and upon receiving the task completion commands, the asynchronous user interface instructs the RPA agent to complete the task once possible. In an embodiment, the RPA agent checks the current state of the software to determine whether the current state allows for the performance of the selected task to be completed. Upon a determination that the current state allows for the performance of the task to be completed, the RPA agent performs the task. Upon a determination that the current state does not allow for the performance of the task to be completed, the RPA agent retries to perform the task until the current state of the software enables allows the performance of the selected task to be completed.

Illustrative embodiments further include learning and defining a series of steps between the selection of a particular selection option and returning to a previous state. In an embodiment, the process defines a previous state of a software application. Accordingly, the previous state may include the initial state of the application prior to a user performing any specific action. The previous state may be likewise referred to as a home state or a steady state. An example of a previous state may include a home page of a website or a search bar. Another example of a previous state may include a web-page including a search bar. For example, suppose a term is entered into a search bar appearing on a home page of a search engine website, and in response to entering the term into the search bar, the search engine displays a set of search results on a new page. In such a scenario, the previous state includes the home page of the search engine website.

In an embodiment, the learning and defining the series of steps may be accomplished via task mining and/or process mining. In an embodiment, a web-based agent records and captures a model of a sample UI as a happy path for each of the selection options from a corpus of possible actions. Accordingly, a web-based agent may record a happy path for an accomplishment of a task for each selection option from the corpus of selection options, and the process may construct a preliminary UI based on the happy path recorded for the accomplishment of each task. In an embodiment, the process associates the one or more actions with other data based on significance and/or a comparison to functional data as propagated and/or maintained within the process mining and/or task mining of the artefact, instance, etc.

Illustrative embodiments further include learning which actions and selection options correspond to the accomplishment of particular tasks. In an embodiment, the learning may be based on the HTML DOM structure of the web-page. In an embodiment, the learning may be based on the HTML CSS of the web-page. Accordingly, CSS elements may be linked to button, menu items, etc., that enable the CSS to provide an indication of UI elements. In an embodiment, the learning may be based on a sequence of keystrokes that one or more users commonly performs to complete one or more actions. For example, a sequence of keystrokes may include “CTRL+C” to copy data, and “CTRL+V” to paste data. In an embodiment, the learning may include differentiating between different potentially diverging responses offered to different users based on profile data.

In an embodiment, the learning may include differentiating between different potentially diverging responses offered to different users based on profile data. For example, User A may accomplish a task via steps A, B, C, whereas User B may accomplish a task via steps D. E. F. In the accordance with the example scenario, an RPA agent may be trained to perform a particular task based on how a particular user performs said task, so that, for example, for User A, the RPA agent performs the tasks by performing steps A, B, C, while for User B, the RPA agent performs the task by performing steps D, E, F.

In an embodiment, the process monitors a user's actions and interactions across a web-browser via an embedded web-browser agent. The process may include embedding a web-browser agent into a web-browser, such that the web-browser agent is able to monitor, record, and analyze user actions in the web-browser, as well as autonomously perform one or more tasks in the web-browser. As used throughout the present disclosure, the term “web-browser agent” refers to a software program configured to monitor and record user actions across a web browser of a digital platform, such as a website or web-based application. Although a web-based agent is described in connection with some embodiments described herein, it is understood that embodiments may be modified to work in conjunction with any type of computer application, including any offline computer program product or any online computer program product.

In a particular embodiment, the process for providing an asynchronous user interface and completing actions via a web-based agent may include the following sequence of steps. First, an initial state is defined. The process provides an interface, wherein the interface includes a set of selection options. The process receives a selection of a selection option of the set of selection options. The process performs a post-selection response upon receiving the selection. The process returns to the initial state upon having completed the performing of the post-selection response. In an embodiment, the process appends each step of the above-mentioned sequence of steps with relevant data including data related to the required state to consume a specific selection option to accomplish a specific task. In an embodiment, when the user selects and instance of item (e.g., button to display a menu) the process provides a full list of selection options (e.g., menu options) irrespective of the present state, and the RPA agent may perform a desired action associated with the selected option upon detecting a suitable state to perform the desired action.

In an embodiment, the asynchronous user interface includes a list of selection options that includes the full set of possible selection options. If a selection option is available given a current state, then the user may be permitted to manually complete the task. For example, if the user clicks a link to fill out a form, then the user may proceed to fill out the form. However, suppose a scenario where a user selects an option to rename a document while the document is open by another user, and in such a scenario the software is in a state that prevents a user from renaming a document while the document is open by another user. In such a scenario, the user may rename the document while the document is open by another user, and the RPA agent may proceed to rename the document once the state permits, for example, once the second user exits out of the document.

An embodiment includes training a machine learning model to learn associations between actions and selection options. Accordingly, the machine learning model may iteratively learn the repetitive patterns of successful actions to provide a greater likelihood of performing autonomous actions that resemble the repetitive successful actions.

In an embodiment, the process associates actions that are used in conjunction to complete a task. For example, suppose a user routinely copies items A, B, and C from an invoice document and proceeds to paste items A, B, C, into rows 1, 2, 3 in a spreadsheet document. In such scenario, the web-agent may detect the repetitive pattern of copying items A, B, C, from an invoice document and pasting items A, B, and C into rows 1, 2, and 3 of the spreadsheet document. Further, in such scenario, the process may construct an additional button on the asynchronous user interface that is provided to automatically extract data from an invoice and insert the data into the spreadsheet; or more broadly, to extract data from a first document, and insert the data into a second document. The scenario described above is only used for explanatory purposes, and as such is not intended as a limiting aspect of the present disclosure. Accordingly, the process may construct an additional button or buttons to automatically complete any task that is repetitively performed through the performance of two or more separate actions that the process associates with each other for the completion of the particular performed task.

In some embodiments, particular types of actions and/or interactions may be excluded from the interaction database. In some such embodiments, particular types of actions and/or interactions excluded from the interaction database may include, but are not limited to, actions involving sensitive and/or private data, actions involving security, actions involving providing authorization credentials, etc.

Illustrative embodiments include providing a screen-reader configured to read selection options of a user interface. In an embodiment, the screen reader reads the DOM elements of a DOM of the asynchronous user interface and causes the computer system to play audio corresponding to the DOM elements corresponding to selection options of the asynchronous user interface.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

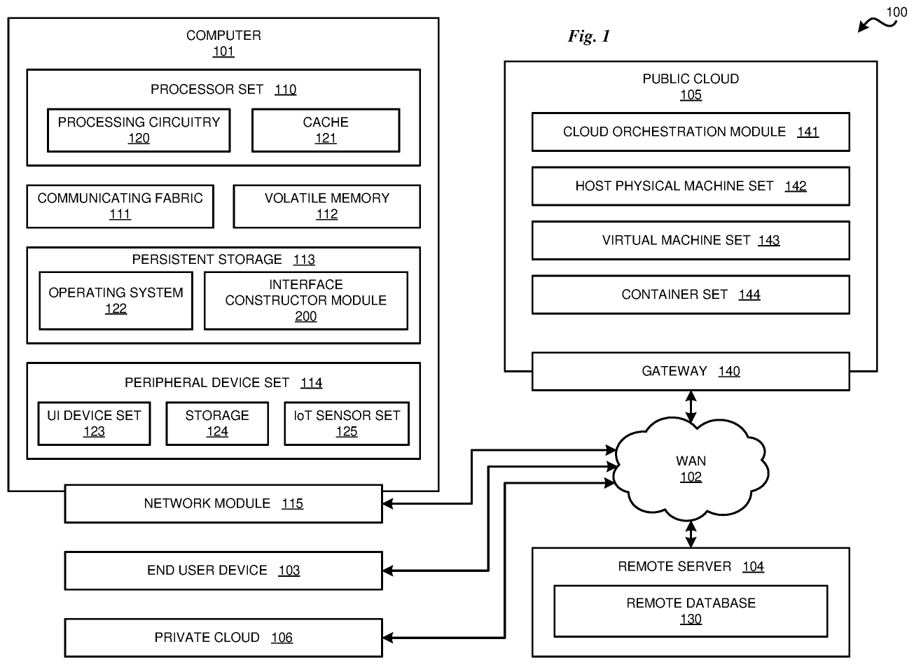

With reference to FIG. 1, this figure depicts a block diagram of a computing environment 100. Computing environment 100 contains an example of an environment for the execution of at least some of the computer code involved in performing the inventive methods, such as providing a interface constructor module 200 that constructs an asynchronous user interface and enables execution of commands input into the asynchronous user interface autonomously via a software robot. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

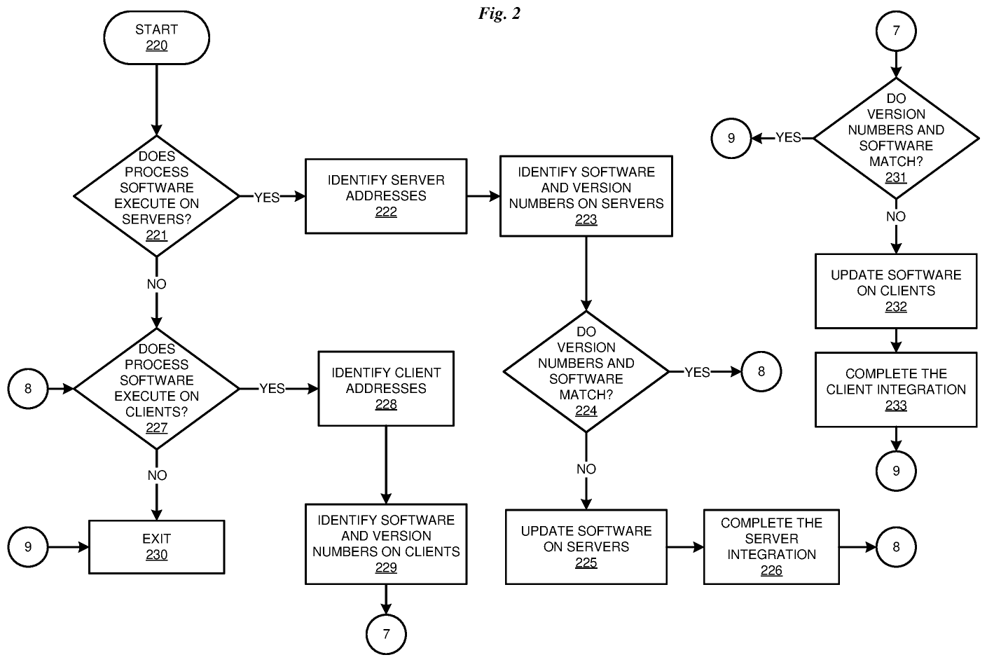

With reference to FIG. 2, this figure depicts a flowchart of an example process for software integration in accordance with an illustrative embodiment. The process software including the asynchronous user interface agent is integrated into a client, server and network environment, by providing for the process software to coexist with applications, operating systems and network operating systems software and then installing the process software on the clients and servers in the environment where the process software will function.

The integration process identifies any software on the clients and servers, including the network operating system where the process software will be deployed, that are required by the process software or that work in conjunction with the process software. This includes software in the network operating system that enhances a basic operating system by adding networking features. The software applications and version numbers will be identified and compared to the list of software applications and version numbers that have been tested to work with the process software. Those software applications that are missing or that do not match the correct version will be updated with those having the correct version numbers. Program instructions that pass parameters from the process software to the software applications will be checked to ensure the parameter lists match the parameter lists required by the process software. Conversely, parameters passed by the software applications to the process software will be checked to ensure the parameters match the parameters required by the process software. The client and server operating systems, including the network operating systems, will be identified and compared to the list of operating systems, version numbers and network software that have been tested to work with the process software. Those operating systems, version numbers and network software that do not match the list of tested operating systems and version numbers will be updated on the clients and servers in order to reach the required level.

After ensuring that the software, where the process software is to be deployed, is at the correct version level that has been tested to work with the process software, the integration is completed by installing the process software on the clients and servers.

Step 220 begins the integration of the process software. An initial step is to determine if there are any process software programs that will execute on a server or servers (221). If this is not the case, then integration proceeds to 227. If this is the case, then the server addresses are identified (222). The servers are checked to see if they contain software that includes the operating system (OS), applications, and network operating systems (NOS), together with their version numbers that have been tested with the process software (223). The servers are also checked to determine if there is any missing software that is required by the process software (223).

A determination is made if the version numbers match the version numbers of OS, applications, and NOS that have been tested with the process software (224). If all of the versions match and there is no missing required software, the integration continues (227).

If one or more of the version numbers do not match, then the unmatched versions are updated on the server or servers with the correct versions (225). Additionally, if there is missing required software, then it is updated on the server or servers (225). The server integration is completed by installing the process software (226).

Step 227 (which follows 221, 224 or 226) determines if there are any programs of the process software that will execute on the clients. If no process software programs execute on the clients, the integration proceeds to 230 and exits. If this not the case, then the client addresses are identified (228).

The clients are checked to see if they contain software that includes the operating system (OS), applications, and network operating systems (NOS), together with their version numbers that have been tested with the process software (229). The clients are also checked to determine if there is any missing software that is required by the process software (229).

A determination is made if the version numbers match the version numbers of OS, applications, and NOS that have been tested with the process software (231). If all of the versions match and there is no missing required software, then the integration proceeds to 230 and exits.

If one or more of the version numbers do not match, then the unmatched versions are updated on the clients with the correct versions 232. In addition, if there is missing required software, then it is updated on the clients 232. The client integration is completed by installing the process software on the clients 233. The integration proceeds to 230 and exits.

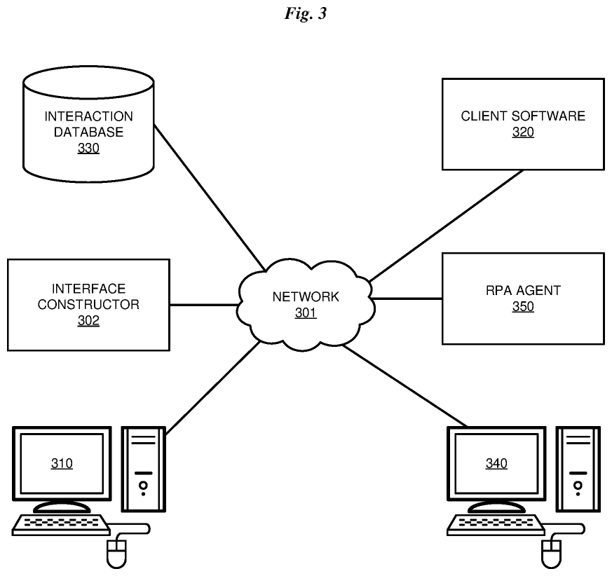

With reference to FIG. 3, this figure depicts example computing environment in accordance with an illustrative embodiment. In the illustrated embodiment, interface constructor module 302 includes interface constructor module 200 of FIG. 1.

In the illustrated embodiment, a user device 340 is shown accessing client software 320 via network 301. In an embodiment, network 301 includes any suitable network or combination of networks such as the Internet, etc. and may use any suitable communication protocols such as Wi-Fi, Bluetooth, etc., to enable user device 340 to access client software 320. In an embodiment, client software 320 includes a website and/or a web application. In some embodiments, client software 320 is stored on a remote storage device (not shown). In some other embodiments, client software 320 is stored on a non-transitory computer readable medium of user device 340. User device 340 may include any suitable computing device, including but not limited to, a desktop computer, a laptop, a tablet, a smartphone, etc.

In the illustrated embodiment, an interface constructor module 302 is shown. In an embodiment, interface constructor module 302 is a software module configured to construct a user interface based at least in part on one or more actions taken by user of user device 340 accessing client software 320. In an embodiment, the interface constructor module 302 constructs an asynchronous user interface which upon interaction with a user causes an RPA agent 350 to perform one or more actions based on the interaction with the asynchronous UI via the standard user interface of the client software 320. In the illustrated embodiment, interaction database 330 stores interaction session data related to one or more user interactions with client software 320. In an embodiment, interface constructor module 302 constructs an asynchronous user interface based at least in part on historical interaction session data stored on interaction database 330. In an embodiment, interaction database 330 stores a corpus of user actions taken by one or more users accessing client software 320. In the illustrated embodiment, administrative device 310 enables a person having suitable administrative privileges to modify one or more parameters and/or features associated with interface constructor 302.

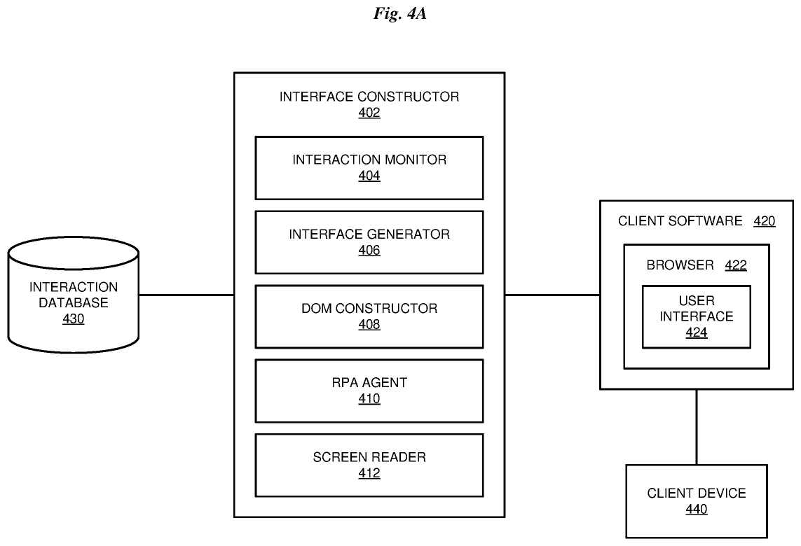

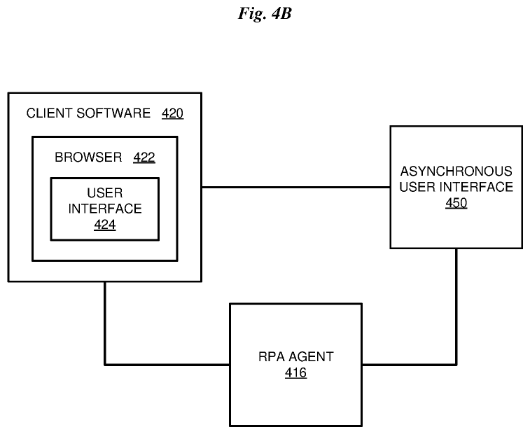

With reference to FIG. 4A, this figure depicts a block diagram of an example interface constructor module. In the illustrated embodiment, the interface constructor module 402 includes the interface constructor module 200 of FIG. 1 and/or interface constructor module 302 of FIG. 3.

In the illustrated embodiment, the interface constructor module 402 is a software module. In the illustrated embodiment, the interface constructor module 402 includes an interaction monitor module 404, an interface generator module 406, a DOM constructor module 408, an RPA agent module 410, and a screen reader module 412. In alternative embodiments, the interface constructor module 402 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the interaction monitor module 404 is a software module. In an embodiment, the interaction monitor module 404 monitors user actions and interactions with the user interface 424 of the browser 422 of the client software 420. In an embodiment, the interaction monitor module 404 utilizes RPA agent 416 to monitor a user's actions and interactions with the user interface 424. In an embodiment, the interaction monitor module 404 may initiate a monitoring session, during which the RPA agent 416 monitors a user's actions for a predetermined period of time to obtain a user interaction session. Accordingly, the user interaction session may include any number of actions taken by a user during the monitoring session. In an embodiment, the user may initiate a monitoring session via the interaction monitor module 404. In some other embodiments, the interaction monitor module 404 monitors user actions and interactions with the user interface 424 continuously, and may automatically begin monitoring the user's actions and interactions upon detection of any user action or engagement with the client software 420. In an embodiment, the interface constructor 402 initiates learning upon detection of one or more actions stored in the action corpus.

In an embodiment, the interface constructor module 402 includes a backend administration system that allows users with administrative privileges to perform various administrative tasks associated with the interface constructor module 402 as described herein, such as initiating a data collection and/or correlation process or a neural network training process.

With reference to FIG. 4B, this figure depicts a block diagram an example software architecture including an asynchronous user interface in accordance with an illustrative embodiment. In the illustrated embodiment, an asynchronous user interface 450 is constructed by the interface constructor 402 of FIG. 4A.

In the illustrated embodiment, the RPA agent 416 monitors and analyzes user interactions with the user interface 424 of the browser 422 of client software 420. Accordingly, the user interaction data corresponding to the one or more user interactions detected by RPA agent 416 is used to construct the asynchronous user interface 450. When a user selects/clicks one or more options of a set of selection options of asynchronous user interface 450, the asynchronous user interface 450 may send a signal instructing the RPA agent 416 to complete a task via the user interface 424 once possible. In an embodiment, the RPA agent 416 checks the current state of the of the software 420 to determine whether the current state allows for the performance of the selected task to be completed. Upon a determination that the current state allows for the performance of the task to be completed, the RPA agent 416 performs the task. Upon a determination that the current state does not allow for the performance of the task to be completed, the RPA agent 416 retries to perform the task until the current state of the software enables the performance of the selected task to be completed.

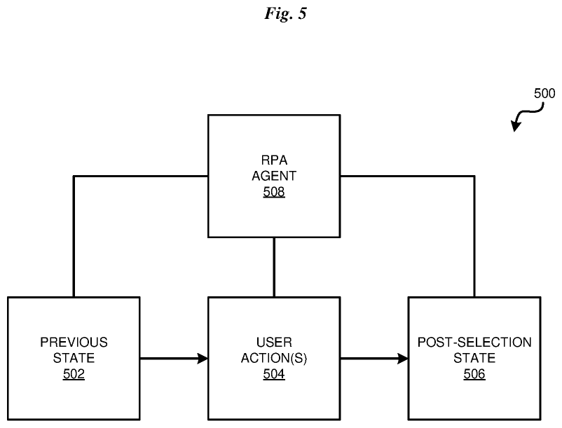

With reference to FIG. 5, this figure depicts a block diagram of an example process for training an RPA agent. In an embodiment, the process 500 defines a previous state 502. The previous state may include, but is not limited to, a home page, a search bar, a login portal, etc. Further, based on one or more user action(s) 504 taken by a user and the post-selection state 506, the process 500 learns a particular set of user actions to execute to move from the previous state 502 to the post-selection state 506. For example, suppose a previous state 502 is a home page that includes a plurality of menu options, including a first menu option, a second menu option, a third menu option, etc. Further, suppose a user arrives at an application page containing bookkeeping records after selecting the second menu option. In such a scenario, the RPA agent 508 may define the second menu option of the previous state 502 as corresponding to the bookkeeping records page arrived at the post-selection state 506.

In the illustrated embodiment, the process 500 may be an iterative process generally comprising the following steps: starting at a steady state, selecting a selection option, arriving at a post-selection state, and returning to a previous (steady) state. The process 500 appends each of these steps with the relevant data with an emphasis on the state needed for an instance to consume specific selection options. In an embodiment, the process 500 includes training a machine learning model to learn associations between actions and selection options. Accordingly, the machine learning model may iteratively learn the repetitive patterns of successful actions to provide a greater likelihood of performing autonomous actions that resemble the repetitive successful actions.

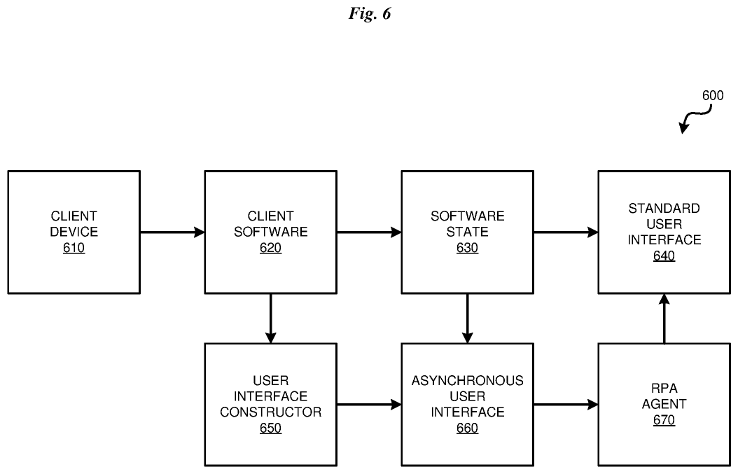

With reference to FIG. 6, this figure depicts a block diagram of an example process for constructing an asynchronous user interface agent in accordance with an illustrative embodiment. In the illustrated embodiment, client device 610 deploys client software 620. Further, the client software 620 may be instanced in a particular software state 630. The software state 630 may include one of at least a normal state or a non-fully operational state. In a scenario where the software state 630 exhibits a normal state, the software may retain full operability. Accordingly, a user engaging the client software 620 whilst the software state 630 exhibits a normal state is enabled to perform any task within the software that the user may ordinarily perform under normal operating conditions. Further, in a normal state, the user may utilize full operability of the software user interface 640.

It is contemplated that in certain scenarios, the software state 630 may exhibit a non-fully operational state. For example, it may be the case that the software is undergoing an update, in which case not all of the features available during a normal operating condition may be available. In such a scenario, a user may be ordinarily be provided with a modified software user interface that includes fewer selection options as compared to the standard user interface 640 provided during normal operating conditions. When the user selects a UI element from asynchronous user interface 660, they are presented with the full list of options irrespective of state, and the RPA agent 670 residing in the browser captures the selection and desired next steps. RPA agent 670 stores the user's selection options and iteratively retries on availability to re-execute and attempt the action when an event of the UI or item changes to support the new option.

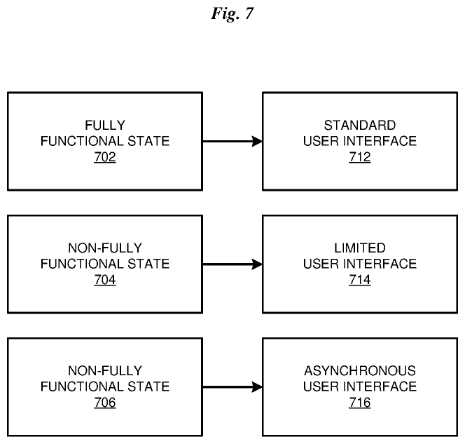

With reference to FIG. 7, this figure depicts a block diagram of multiple example states and corresponding provided user interfaces. The multiples example states depicted in the figure include a first state 702 representing a fully functional state, a second state 704 representing a non-fully functional state, and a third state 706 representing a non-fully functional state.

In the illustrated embodiment, a first state 702 represents a fully functional state of an application, during which a standard user interface 712 is available to be engaged with by a user. In the illustrated embodiment, a second state 704 represents a non-fully functional state, during which a limited user interface 714 is available to a user. As discussed herein, there may exist instances during which an application does not exhibit full ordinary functional. In such a scenario, a limited user interface 714 may be provided in place of a standard user interface 712 that otherwise may be provided, such that the limited user interface 714 includes fewer selection options than the standard user interface 712.

In the illustrated embodiment, a third state 706 represents a non-fully functional state 706, during which a fully functional asynchronous user interface 716 is provided to a user. In such scenario, a user selection via the asynchronous user interface 716 may be executed by an RPA agent via the standard user interface 712 when the application is in a fully functional state again during which the standard user interface 712 is available.

In an embodiment, the asynchronous user interface 716 may be provided irrespective of the present state of the application, so that the asynchronous user interface 716 is state-independent and provided regardless of the present state of the application. In such a scenario, a user selection via the asynchronous user interface 716 may be executed by an RPA agent via the standard user interface 712 when the application is in a fully functional state again during which the standard user interface 712 is available. In an embodiment, the asynchronous user interface 716 may include additional selection options as compared to the standard user interface 712, as described in greater detail herein. In an embodiment, the RPA agent executes steps to complete a task when software is in any state that enables the completed of the task, not necessarily limited to a fully functional state where all possible tasks may be complete.

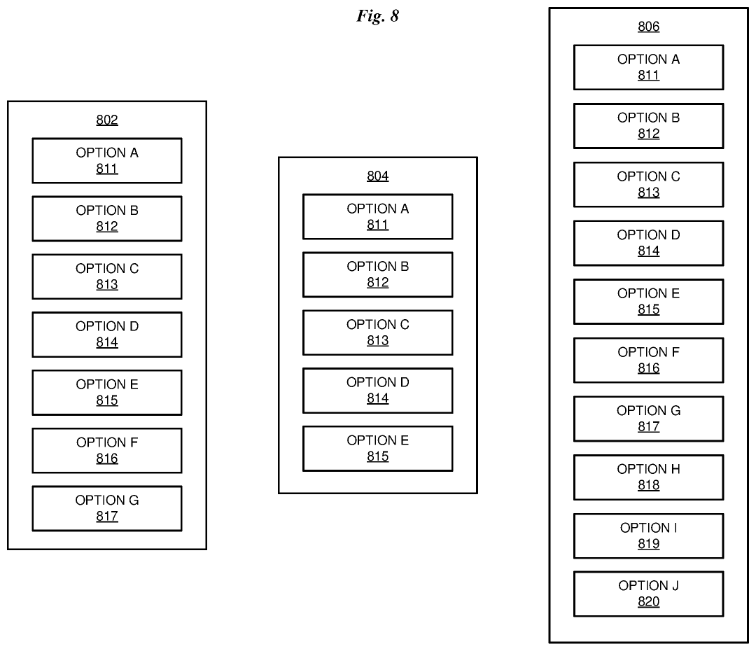

With reference to FIG. 8, this figure depicts a block diagram of multiple example user interfaces in accordance with an illustrative embodiment. In the illustrated embodiment, the multiple examples interfaces includes a standard user interface 802, a limited user interface 804, an asynchronous user interface 806. In the illustrated embodiment, the standard user interface 804 may include the standard user interface 712 of FIG. 7, the limited user interface 804 may include the limited user interface 714 of FIG. 7, and the asynchronous user interface 806 may include the asynchronous user interface 716 of FIG. 7.

In the illustrated embodiment, the standard user interface 802 is shown including a plurality of selection options, including Option A 811, Option B 812, Option C 813, Option D 814, Option E 815, Option F 816, Option G 817. The plurality of selection options depicts a list or array of selection options that may ordinarily be available to a user to select during a fully functional state of an application. As a nonlimiting illustrative example, the standard user interface 802 includes seven selection options, as shown. In comparison to the standard user interface 802, the limited user interface 804 depicted includes fewer selection options. Accordingly, during a non-fully functioning state of the application, a user may be provided a limited user interface 804 that provides fewer selection options. In the scenario depicted by FIG. 8, the limited user interface 804 does not include Option F nor Option G. It is contemplated that different selection options may be available depending on the state of the application.

In the illustrated embodiment, the asynchronous user interface 806 is shown including additional selection options compared to the limited user interface 804 as well as the standard user interface 802. In comparison to the standard user interface 802, the asynchronous user interface 806 includes additional options, including Option H 818, Option I 819, and Option J 820. In an embodiment, the additional selection options, including Option H 818, Option I 819, and Option J 820, may be based on user interaction within the application. For example, it may be the case that a user routinely performs certain actions in series and/or within a close temporal proximity to each other, such as for example, copy-pasting, wherein a user may routinely copy data from a particular document, and subsequently enter the data into a separate document. In such a scenario, one of the additional user selection options may represent said copy-paste actions, such that when the appropriate user selection option is selected, an RPA agent may execute said actions automatically. It is contemplated that any number of additional selection options may be provided via the asynchronous user interface 806.

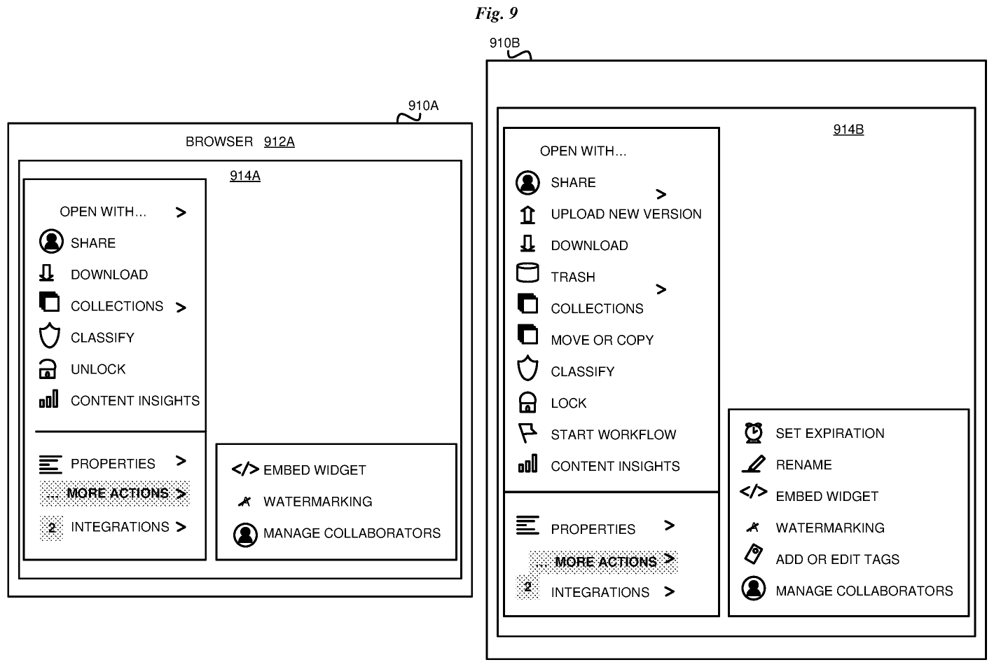

With reference to FIG. 9, this figure depicts a block diagram of multiple example browser user interfaces in accordance with an illustrative embodiment. In the illustrated embodiment, application 910A represents an application in a non-fully functional state, in which the browser 912A includes a limited user interface 914A. In the illustrated embodiment, application 910B represents the same application as application 910A also in a non-fully functional state, however application 910B includes a browser 912B that includes an asynchronous fully functional user interface 914B. In the illustrated embodiment, although the application 910B is in a non-fully functional state, the asynchronous fully functional user interface 914B enables a user to utilize a user interface that mirrors a standard user interface that may be available under a fully-operational normal operating condition.

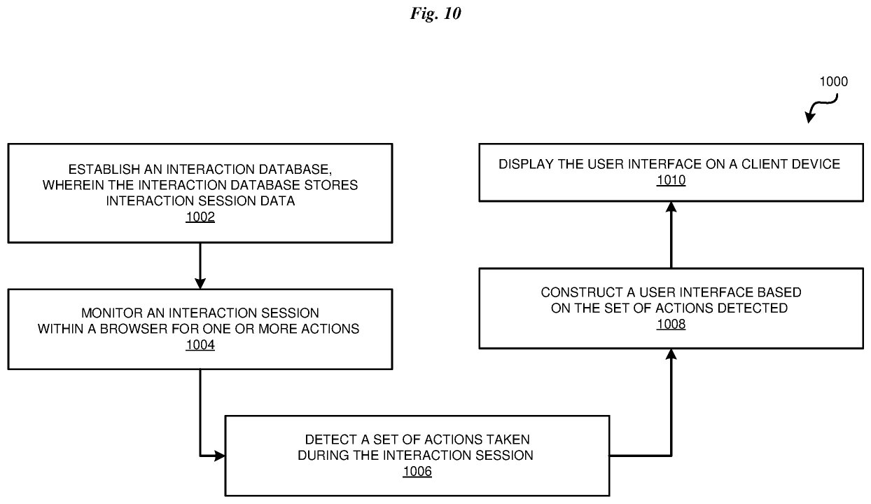

With reference to FIG. 10, this figure depicts a flowchart of an example process for constructing a user interface in accordance with an illustrative embodiment. In an embodiment, interface constructor module 200 of FIG. 1 carries out process 1000.

At step 1002, the process establishes an interaction database. In an embodiment, the interaction database includes interaction session data corresponding to one or more previous user interactions within a particular browser. In an embodiment, the process receives interaction session data from a web browser via an RPA agent and stores the interaction session data on the interaction database.

At step 1004, the process monitors an interaction session within a browser for one or more actions. In some embodiments, the process monitors an interaction session for a predetermined period of time. In some such embodiments, interaction session data is obtained upon execution of a command to initialize monitoring of an interaction session. In some other embodiments, the process monitors actions for one or more actions taken within the web-browser continuously. In an embodiment, the process records a happy path to accomplish a certain action within the web-browser. Accordingly, the process may define a first state, and record one or more actions taken to achieve a second state, wherein the first state may be defined as a steady state, while the second state may be defined as a post-selection state achieved by selecting a particular option presented in the user interface of the browser.

At step 1006, the process detects a set of actions taken during the interaction session. Accordingly, the process monitors an interaction session within a browser and subsequently detects a set of actions that have been taken during the interaction session. The set of actions taken during the interaction session may include, but are not limited to, clicking a UI element, entering text into a text box, pressing a combination and/or sequence of keys, etc.

At step 1008, the process constructs a user interface based on the set of actions detected while monitoring the interaction session between a user and the user interface of the web-browser. In an embodiment, the user interface includes an asynchronous user interface configured to represent a fully functional user interface irrespective of the present software state. In an embodiment, selection of a selection option of the asynchronous user interface causes an RPA agent to carry out one or more actions necessary to complete a desired task autonomously in a suitable software state. At step 1010, the process displays the user interface on a client device.

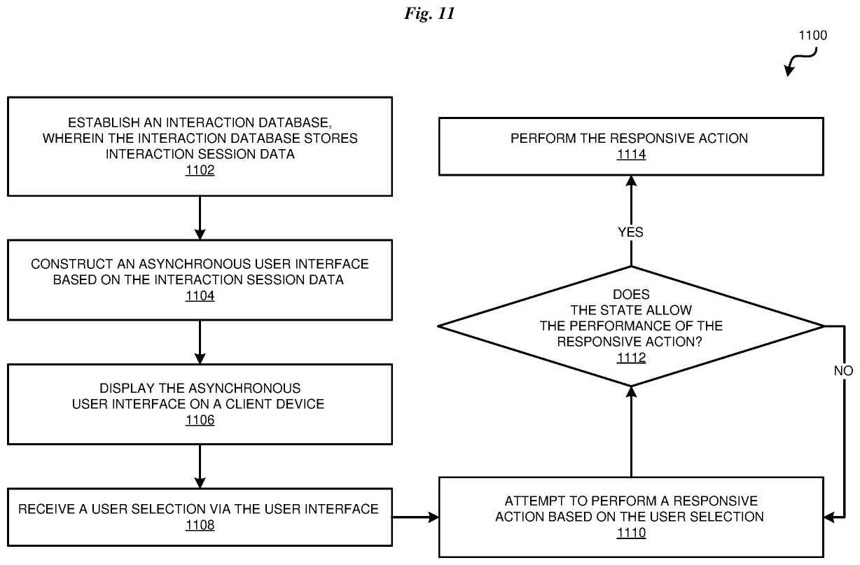

With reference to FIG. 11, this figure depicts a flowchart of an example process for providing an asynchronous user interface to facilitate functionality during a non-fully functional state. In an embodiment, interface constructor module 200 of FIG. 1 carries out process 1100.

At step 1102, the process establishes an interaction database. Accordingly, the interaction database may be established from receiving interaction session data obtained during monitoring one or more interaction sessions for one or more actions. The one or more actions may include, but are not limited to, selecting/clicking a user interface component, entering text into a search bar, pressing a combination of keys on a keyboard in a particular order, etc. In an embodiment, the monitoring of an interaction session may be accomplished via an RPA agent configured to observe and record actions taken across a software application.

At step 1104, the process constructs an asynchronous user interface based at least in part on the interaction session data stored on the interaction database. Accordingly, the interaction session database may include data representative of actions taken across a software application, that may be utilized to construct the asynchronous user interface. In an embodiment, the HTML DOM structure of the browser of the application may be utilized to construct the asynchronous user interface. At step 1106, the process displays the asynchronous user interface on a client device.

At step 1108, the process receives a user selection via the asynchronous user interface. At step 1108, upon receiving a selection option, the asynchronous user interface causes an RPA agent to attempt to perform a responsive action based on the user selection. At step 1112, the process checks whether a current state allows performance of the responsive action. At step 1114, upon a determination that the current state allows performance of the responsive action, the RPA agent performs the responsive action. Else, if the current state does not allow performance of the responsive action, the process continues to step 1110, and the process retries and attempts to perform the responsive action again.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
establishing an interaction database based at least in part on interaction data received from a browser;
monitoring the browser for one or more actions and storing the one or more actions detected during the monitoring as interaction data on the interaction database;
constructing an asynchronous user interface based at least in part on the interaction data stored on the interaction database, wherein the asynchronous user interface comprises a set of selection options;
receiving, via the asynchronous user interface, a selection of a selection option of the set of selection options; and
performing a responsive action upon having received the selection of the selection option of the set of selection options.

2. The computer-implemented method of claim 1, wherein the monitoring is accomplished via a software robot embedded in the browser.

3. The computer-implemented method of claim 1, wherein the performing the responsive action upon having received the selection of the selection option is accomplished via a software robot.

4. The computer-implemented method of claim 1, further comprising training a software robot to perform one or more automatic actions to accomplish one or more tasks corresponding to each selection option of the set of selection options.

5. The computer-implemented method of claim 4, wherein training the software robot comprises performing a happy path demonstrating a successful accomplishment of each task corresponding to each selection option of the set of selection options.

6. The computer-implemented method of claim 1, wherein performing the responsive action comprises checking a current software status, determining whether the current software status comprises a suitable status, and, upon determination that the current software status comprises the suitable status, performing the responsive action.

7. The computer-implemented method of claim 1, wherein the one or more actions comprises at least one of selecting a standard interface element present in the browser, entering text into a box, or pressing one or more keys.

8. The computer-implemented method of claim 1, further comprising constructing a temporary DOM structure, the DOM structure comprising a set of DOM elements corresponding to the set of selection options of the asynchronous user interface, and playing audio corresponding to each of the DOM elements.

9. The computer-implemented method of claim 1, further comprising associating two or more actions to each other, and wherein constructing the asynchronous user interface further comprises providing an additional selection option to automatically perform the two or more actions that have been associated to each other.

10. The computer-implemented method of claim 1, further comprising excluding one or more security related actions from being stored in the interaction database.

11. A computer program product comprising one or more computer readable storage media, and program instructions collectively stored on the one or more computer readable storage media, the program instructions executable by a processor to cause the processor to perform operations comprising:
establishing an interaction database based at least in part on interaction data received from a browser;
monitoring the browser for one or more actions and storing the one or more actions detected during the monitoring as interaction data on the interaction database;
constructing an asynchronous user interface based at least in part on the interaction data stored on the interaction database, wherein the asynchronous user interface comprises a set of selection options;
receiving, via the asynchronous user interface, a selection of a selection option of the set of selection options; and
performing a responsive action upon having received the selection of the selection option of the set of selection options.

12. The computer program product of claim 11, wherein the stored program instructions are stored in a computer readable storage device in a data processing system, and wherein the stored program instructions are transferred over a network from a remote data processing system.

13. The computer program product of claim 11, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

14. The computer program product of claim 11, wherein the performing the responsive action upon having received the selection of the selection option is accomplished via a software robot.

15. The computer program product claim 14, further comprising training the software robot to perform one or more automatic actions to accomplish one or more tasks corresponding to each selection option of the set of selection options.

16. The computer program product claim 14, wherein training the software robot comprises performing a happy path demonstrating a successful accomplishment of each task corresponding to each selection option of the set of selection options.

17. The computer program product claim 11, wherein performing the responsive action comprises checking a current software status, determining whether the current software status comprises a suitable status, and, upon determination that the current software status comprises the suitable status, performing the responsive action.

18. A computer system comprising a processor and one or more computer readable storage media, and program instructions collectively stored on the one or more computer readable storage media, the program instructions executable by the processor to cause the processor to perform operations comprising:
establishing an interaction database based at least in part on interaction data received from a browser;
monitoring the browser for one or more actions and storing the one or more actions detected during the monitoring as interaction data on the interaction database;
constructing an asynchronous user interface based at least in part on the interaction data stored on the interaction database, wherein the asynchronous user interface comprises a set of selection options;
receiving, via the asynchronous user interface, a selection of a selection option of the set of selection options; and
performing a responsive action upon having received the selection of the selection option of the set of selection options.

19. The computer system of claim 18, wherein the performing the responsive action upon having received a selection of the selection option is accomplished via a software robot.

20. The computer system of claim 19, further comprising training the software robot to perform one or more automatic actions to accomplish one or more tasks corresponding to each selection option of the set of selection options.
